(19) United States
(12) Patent Application Publication
(10) Pub. No.: US 2014/0015969 A1
(43) Pub. Date: Jan. 16, 2014

(54) WIDE AREA AIRBORNE HIGH SPEED CAMERA

(71) Applicant: BAE Systems Information and Electronic Systems Integration Inc., Nashua, NH (US)

(72) Inventor: Barry Lavoie, Lowell, MA (US)

(21) Appl. No.: 13/870,013

(22) Filed: Apr. 25, 2013

Related U.S. Application Data
(60) Provisional application No. 61/670,239, filed on Jul. 11, 2012.

(51) Int. Cl. H04N 7/18

(52) U.S. Cl. CPC H04N 7/18
USPC 348/144

(57) ABSTRACT

In the method of wide area airborne surveillance, the improvement comprising a single focal plane array camera assembly, said assembly comprising two points of rotation and capable of mapping a plurality of exposures to form one wide area airborne image.

### RELATED APPLICATIONS

This application claims the benefits of U.S. Provisional Application No. 61/670,239 filed Jul. 11, 2012 which is herein incorporated by reference in its entirety for all purposes.

### FIELD OF THE INVENTION

The present invention relates to airborne surveillance and, more particularly, to high speed, wide-area cameras.

### BRIEF DESCRIPTION OF PRIOR DEVELOPMENTS

In the field of military surveillance, lightweight and minimum-sized devices are strongly desired and critical for mission success. The leading prior art in this field is the Autonomous Real-Time Ground Ubiquitous Surveillance Imaging System (ARGUS-IS) Sensor Assembly which consists of four individual camera assemblies. The ARGUS-IS provides military users the ability to find, track, and monitor events and activities of interest over a wide area utilizing four focal plane arrays.

A need, therefore exists, for surveillance devices with a single focal plane array, yet capable of achieving high speed surveillance over a wide area at a low cost.

### SUMMARY OF THE INVENTION

The present invention comprises a single focal plane array camera assembly. The assembly has two points of rotation about the center of gravity of the camera. As stated, the prior art. ARGUS-IS consists of four individual camera assemblies, however, one major disadvantage of this technology is the lack of ability to achieve high speed surveillance over a wide area at low cost. The present invention overcomes this disadvantage by incorporating two points of rotation, rotating continuously about those two points, and thus, enabling the single focal plane array camera to survey a wide area. Another advantage of the current invention is an approximately 75% reduction in cost due to the need for three less focal plane array camera assemblies per imaging system.

### BRIEF DESCRIPTION OF THE DRAWINGS

The present invention is further described with reference to the accompanying drawings wherein:

FIG. 1 is an isometric view of the existing ARGUS-IS Sensor Assembly of the prior art.

FIG. 2 is an isometric view of the single focal plane array camera with two rotation points.

FIGS. 3a-d show exposure positions of the single focal plane array camera at various positions.

FIG. 4 shows the mapped focal plane array data.

FIG. 5 the shows the focal plane array.

### DETAILED DESCRIPTION OF THE PREFERRED EMBODIMENT

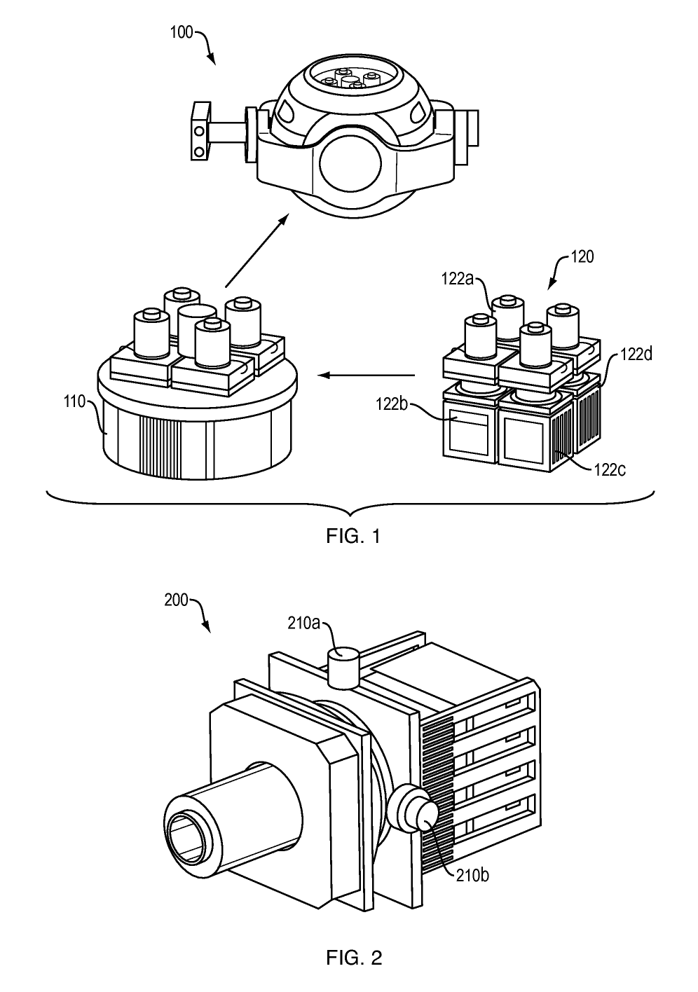

FIG. 1 is an isometric view of the existing ARGUS-IS Sensor Assembly 100 of the prior art. As seen in FIG. 1, the prior art assembly 100 does not teach the use of rotation points, but instead comprises four individual sensors 122a-d which are used to avoid gaps in the image when the 368 separate images are combined into a single master image. The optically active portion (grey inner rectangle) of a CMOS image sensor does not fill the chip on which it is fabricated—there is extra room needed for wiring. If the 368 image sensors of the ARGUS-IS were packed in a single matrix, or only a single camera was used, a significant part of the surveyed field of view would not be imaged.

Instead, the ARGUS-IS sensor assembly has four individual sensors 122a-d and each camera sensor 122a-d feeds one part of the submatrix, and then the four partial images are electronically stitched together into a single image covering the entire field of view. Physically, these sensors are put together in a group 120 which is put into a tight container 110. This container does not allow any freedom of movement of the individual sensors 122a-d.

FIG. 2 is an isometric, view of an embodiment of an aspect of the present invention. The single focal plane array camera sensor 200 shown here has two points of rotation about the center of gravity of the camera sensor 200. A first point of rotation 210a rotates along the X axis and a second point of rotation 210b rotates one along the Y axis. These rotation points enable the sensor 200. Thereby allowing the entire assembly to cover a wider range of area simultaneously.

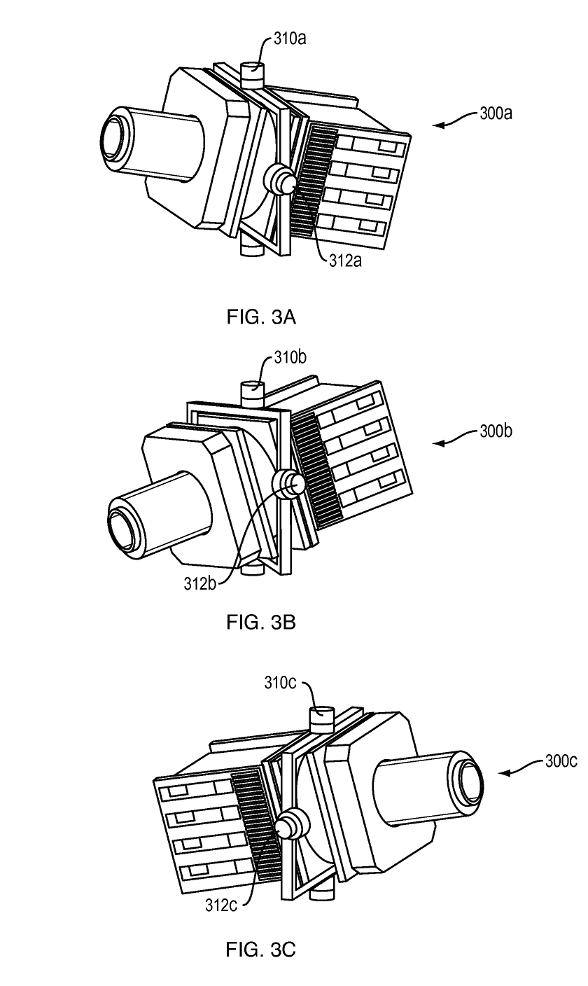

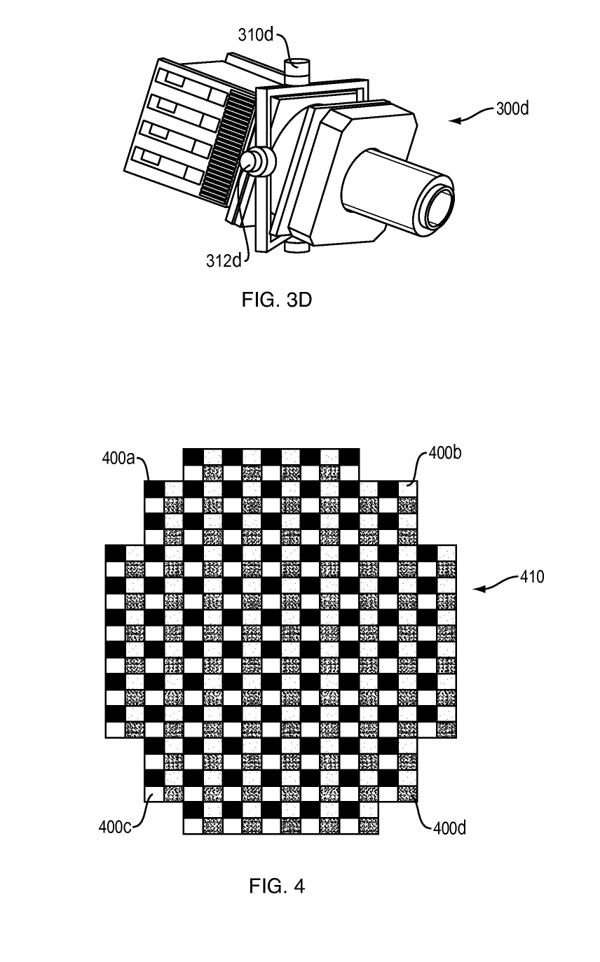

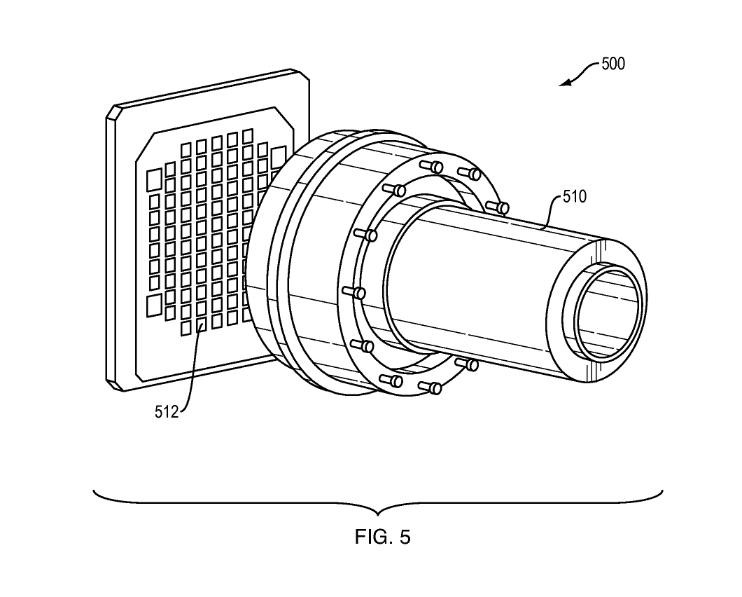

FIGS. 3a-d shows the sensor's various exposures at various times in accordance with the invention. The first, second, third, and fourth exposures correspond to FIGS. 3a, 3b, 3c, and 3d, respectively and discussed in more detail in relation to FIG. 4. The first exposure has a first point of rotation 310a at a certain positive degree in the X direction and a second point of rotation 312a at a certain positive degree in the Y direction. The second exposure has a first point of rotation 310b at a certain positive degree in the X direction and a second point of rotation 312b at a certain negative degree in the Y direction.

The third exposure has a first point of rotation 310c at a certain negative degree in the X direction and a second point of rotation 312c at a certain positive degree in the Y direction. The forth exposure has a first point of rotation 310d at a certain negative degree in the X direction and a second point, of rotation 312d at a certain negative degree in the Y direction.

FIG. 4 shows the resultant mapped focal plane array data from the four exposure positions as discussed in FIGS. 3a-d. These four exposures 300a-d are mapped together to form one wide area, airborne image.

FIG. 5 shows the optical lens assembly 510 of the sensor 500 coupled with the focal plane array 512.

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the recitation of the appended claims.

What is claimed is:

1. A method of wide area airborne surveillance comprising the steps of:
assembling a focal plane array camera;
rotating said local plane array camera;
capturing a plurality of exposures; and
mapping said plurality of exposures to form one wide area airborne image.

2. The method of wide area airborne surveillance of claim 1, wherein the step of rotating said focal plane array camera further comprises the steps of:
rotating along a first point of rotation; and
rotating along a second point of rotation,

3. The method of wide area airborne surveillance of claim 1, wherein the step of assembling a focal plane array camera further comprises assembling one focal plane array camera.

4. The method of wide area airborne surveillance of claim 2, wherein the step of rotating along a first point of rotation further comprises rotating along the X axis.

5. The method of wide area airborne surveillance of claim 2, wherein the step of rotating along a second point of rotation further comprises rotating along the Y axis.

6. The method of wide area airborne surveillance of claim 2, wherein the step of capturing a plurality of exposures further comprises the steps of:
capturing a first exposure
capturing a second exposure;
capturing a third exposure; and
capturing a fourth exposure.

7. The method of wide area airborne surveillance of claim 6, wherein the step of capturing a first exposure captures an image at a first degree in the X direction and a first degree in the Y direction.

8. The method of wide area airborne surveillance of claim 6, wherein the step of capturing a first exposure captures an image at a second degree in the X direction and a second degree in the Y direction.

9. The method of wide area airborne surveillance of claim 6, wherein the step of capturing a first exposure captures an image at a third degree in the X direction and a third degree in the Y direction.

10. The method of wide area airborne surveillance of claim 6, wherein the step of capturing a first exposure captures an image at a fourth degree in the X direction and a fourth degree in the Y direction.
